(19) United States
(12) Patent Application Publication
(10) Pub. No.: US 2005/0132177 A1
(43) Pub. Date: Jun. 16, 2005

(54) Detecting modifications made to code placed in memory by the POST BIOS

(75) Inventors: David Carroll Challener, Raleigh, NC (US); Joseph Wayne Freeman, Raleigh, NC (US); Randall Scott Springfield, Chapel Hill, NC (US)

Correspondence Address: KELLY K. KORDZIK;WINSTEAD SECHREST & MINICK PC, PO BOX 50784, DALLAS, TX, 75201, US

(73) Assignee: International Business Machines Corporation, Armonk, NY (US)

(21) Appl. No.: 10/734,960

(22) Filed: Dec. 12, 2003

(51) Int. Cl. G06F 9/00

(52) U.S. Cl. 713/1

(57) ABSTRACT

A method, computer program product and system for detecting modifications to code placed in memory by the POST BIOS during a POST operation. The POST BIOS may measure the legacy BIOS code and the code supporting the legacy BIOS during the POST operation and storing that measurement in a secure location. After the system runs in an activated state, the system may enter a sleep state after a period of inactivity. After the system receives an awakening event, the boot block code may measure the legacy BIOS code and the code supporting the legacy BIOS code stored in memory. The boot block code may compare the measurement with the value stored in the secure location by the POST BIOS. If the measurement does not equal the value stored in the secure location, then modification of either the legacy BIOS code and/or code supporting the legacy BIOS code is detected.

### TECHNICAL FIELD

The present invention relates to the field of trusted and secure computing systems, and more particularly to detecting modifications made to code, e.g., legacy BIOS, placed in memory by the Power On Self Test (POST) Basic Input/Output System (BIOS).

### BACKGROUND INFORMATION

With the advent of personal computer system use in every day business transactions, the issue of computer security has become critical. Unsecured personal computers inhibit electronic business (e-business) because users are reluctant, justifiably so, to transmit highly personal and sensitive information to system which may be vulnerable to intruders or viruses. While many Personal Computer (PC) manufacturers have made individual strides towards increasing security by adding “smart cards” or embedded security chips to their new models, the lack of a concerted effort by the PC industry to develop security technology could prevent the evolution of this technology in a consistent and compatible way between manufacturers.

Recognizing this potential risk and the adverse effects it could have on inhibiting electronic commerce, an open alliance between major PC manufacturers was formed to develop and propose a standard that would adopt hardware and software technologies to strengthen security at the platform level. The open alliance, formerly known as the Trusted Computing Platform Alliance (TCPA) (currently referred to as the Trusted Computing Group (TCG) but will be referred to herein as the TCPA), has proposed a standard including new hardware, BIOS and operating system specifications so PC manufacturers can provide a more trusted and secure PC platform based on common industry standards, the details of which are provided in the TCPA PC Specific Implementation Specification, 1.00 RC1 (Aug. 16, 2001) (http://www.trustedcomputinggroup.org), hereby incorporated by reference.

A brief discussion of the boot process of a computing system is deemed appropriate here. Computing systems require a basic input/output system (BIOS) in order to operate. The BIOS is code that controls basic hardware operations, such as interactions with disk drives, floppy drives and the keyboard.

When a computer resets or is initially powered-on, a boot process begins. First, a power on self test (POST) begins executing. POST is an initialization code which configures the system utilizing initialization settings stored in storage. Once POST has configured the system, BIOS then controls the basic operation of the hardware utilizing the hardware as it was configured by POST. The boot process is complete once an operating system has been handed control of the system. In order for the boot process to be complete, POST must complete its execution.

POST and BIOS may be both stored as a single flash image in a storage device such as a flash memory. This image may be referred to as the “boot code.” If the flash image of POST and BIOS is corrupted, the boot of the system will not be able to be completed.

To recover from a defective flash image error, a system may include a boot block. A boot block may refer to an area within a flash memory containing code, referred to as the “boot block code,” which includes a segment of code sufficient to bring the computer system up and to read a recovery image from a boot media or bootable device. In other words, the boot block code may be considered to be a self-contained “miniBIOS” with enough code so as to read the new BIOS image off a boot media or the like. The boot block code may be executed when a computer is powered up or reset. The boot block code may further be executed when a computer is awakened from a sleep state as discussed further below.

FIG. 1 is a block diagram illustrating a TCPA computing system 100 in accordance with TCPA standards. As is shown, the PC architecture includes a system 10, platform 20, motherboard or planar 30, and trusted building block (TBB) 40. The system 10 includes the platform 20 and all post-boot components 12. Post-boot components 12 may include Initial Program Load (IPL) code 13, an operating system 14 (comprise the entire entity that performs actions for, or acts on behalf of, a user), drivers 15, services 16, applications 17 and peripherals 18, e.g., display, keyboard. Platform 20 presents and receives information to and from the user. Platform 20 includes motherboard 30 and peripherals 22 attached to motherboard 30. Peripherals 22 may include add-on cards 20, a case 21, a hard disk 23 and a floppy disk 24. Platform 20 may further include a power supply 19.

Motherboard 30 is provided by the manufacturer and includes one or more CPUs 32, a memory 33, an Electrically Erasable Programmable Read Only Memory (EEPROM) 35, and all primary peripheral devices 34, i.e., devices which directly attach to and directly interact with motherboard 30. In addition, motherboard 30 includes all BIOSes 36 (POST BIOS 36 stored in flash memory 42 outside TBB 40), embedded firmware 38 and TBB 40. TBB 40 is the center of the trusted platform, and includes a portion of a flash memory 42 storing a boot block code 50 which includes a Core Root of Trust for Measurement (CRTM) 52. TBB 40 further includes a Trusted Platform Module (TPM) 44, and a trusted connection 46 of CRTM 52 and TPM 44 to motherboard 30.

According to the TCPA specification, CRTM 52 and TPM 44 are the only trusted components on the motherboard 30, i.e., they are presumably secure and isolated from tampering by a third party vendor or software. Only the authorized platform manufacturer (or agent thereof) can update or modify code contained therein. CRTM 52 is the executable component of TBB 40 that gains control of the platform 20 upon a platform reset. Thus, for all types of platform resets, CPU 32 always begins executing CRTM code 52 within boot block code 50. The trust in the platform is based on CRTM 52, and trust in all measurements is based on its integrity.

The basic premise underlying the trusted platform is ensuring that untrusted devices or software have not been loaded onto the system. Trust is established during a pre-boot state that is initiated by a platform reset. The platform reset can either be a cold boot (power-on), a hardware reset, or a warm boot typically caused by a user keyboard input. Following a platform reset, CPU 32 executes code with CRTM's 52 platform initialization code. The chain of trust begins at CRTM 52.

In this architecture, the BIOS includes boot block code 50 and a POST BIOS 36. Boot block code 50 and POST BIOS 36 are independent components and each can be updated independent of the other. Boot block code 50 is located in a portion of flash memory 42 within TBB 40, while POST BIOS 36 is located in another portion of flash memory 42 outside TBB 40. Thus, while the manufacturer or a third party supplier may update, modify or maintain POST BIOS 36, only the manufacturer can modify or update boot block code 50.

As stated above, CRTM 52 and TPM 44 are presumptively trusted. Thus, following a platform reset, CRTM 52 in boot block code 50 is executed, which measures the entity to which it will transfer control, in this case, Post BIOS 36. “Measuring an entity” means hashing code in the entity to produce a log of the code, which is then extended into a platform configuration register (PCR) 48 in TPM 44. TPM 44 includes a plurality of PCRs 48 (48a-d), a portion of which are designated to the pre-boot environment and referred to collectively as boot PCRs 48a. Each boot PCR 48a is dedicated to collecting specific information related to a particular stage of a boot sequence. For example, one boot PCR 48a (PCR[0]) may store measurements from CRTM 52, POST BIOS 36, and all firmware 38 physically bound to the motherboard 30.

Once POST BIOS 36 has been measured, control is transferred to POST BIOS 36, which then continues to boot the system by ensuring that hardware devices are functional. POST BIOS 36 may move code, referred to herein as “legacy BIOS code,” stored in flash memory 42 within TBB 40 to memory 33 during the POST operation. The legacy BIOS code may refer to code that provides certain core functions such as keyboard and basic video support. The legacy BIOS code may be placed in a designated place in memory 33 such as the E000:0 and F000:0 address segments (the addresses of BIOS on the original personal computer) or at the top end of the memory address space. Further, POST BIOS 36 may move code from flash memory 42 to memory 33 used to support the functions of the legacy BIOS code such as Universal Serial Bus (USB) interface support code for USB keyboard operations as well as code used for power management routines, e.g., Advanced Configuration and Power Interface (ACPI) code. These codes may be stored in a different location in the memory address space in memory 33 than the location of the legacy BIOS code.

Further, once POST BIOS 36 gains control, it is responsible for measuring any entity to which it will transfer control. As POST BIOS 36 progresses through the boot sequence, values in the boot PCRs 48a change whenever an entity is measured.

Upon booting to operating system (OS) 14, operating system 14 verifies the trustworthiness of platform 20 by comparing the values in the boot PCRs 48a with precalculated values known by operating system 14. If the values match, operating system 14 is assured of a secure boot and that the platform is trusted. System 100 may then be available for use. If the values do not match, operating system 14 is alerted of a possible breach, and operating system 14 can take measures to reestablish trust.

Once system 100 becomes available for use, system 100 may enter a state, commonly referred to as a “sleep state,” during periods of inactivity. The “sleep state” may refer to a state in which power consumption is reduced. For example, in a state referred to as a “S3” sleep state, the system may only use power to ensure that the contents of its memory remain valid. System 100 may be invoked to enter a sleep mode of operation after a period of inactivity. Upon entering the sleep mode of operation, the state of system 100 may be stored in volatile memory, e.g., Random Access Memory (RAM). For example, register contents storing system state information may be stored in volatile memory during the sleep mode of operation. The “sleeping” computer system may be “awakened” or resumed upon an event such as a user's keystroke, receipt of electronic mail, a fax, etc. That is, upon an awakening event, the computer system exits out of the sleep mode of operation and resumes a normal mode of operation.

Upon the awakening of system 100 from the sleep state, the user of system 100 may be asked to supply an authorization, such as a password, in order to allow system 100 to be awakened. During the awakening of system 100, book block code 50 may access the legacy BIOS code as well as code, e.g., ACPI code, USB interface support code, required to support the legacy BIOS code, in order to awaken system 100.

However, a program, such as a virus, may modify the contents of the legacy BIOS code or other code, e.g., ACPI code, USB interface support code, used to support the legacy BIOS code as these codes are not stored in a secure area, e.g., within TBB 40, but instead are stored in a non-secure area, e.g., memory 33. For example, a Trojan horse routine may be implanted in the legacy BIOS code to capture hardfile password keystrokes entered by the user upon the awakening of system 100. Upon the capture of the password, another user may access the operating system of the system and consequently remove the contents of the hardfile to be stored on another system.

If, however, modifications to the legacy BIOS code or code used to support the legacy BIOS code were detected prior to exiting the sleep state, then the system may be prevented from being awakened thereby preventing a virus from capturing password keystrokes.

Therefore, there is a need in the art to detect modifications to the legacy BIOS code or code used to support the legacy BIOS code after the booting of the system upon the exiting of the sleep state.

### SUMMARY

The problems outlined above may at least in part be solved in some embodiments by having the POST BIOS measure the legacy BIOS code and the code supporting the legacy BIOS code during the POST operation and storing that measurement in a secure location. The legacy BIOS code and the code supporting the legacy BIOS code may be stored in memory by the POST BIOS during the POST operation. After the POST operation completes and the operating system is booted, the system may run in an activated state. The system may then enter a sleep state after a period of inactivity. Upon the system receiving an awakening event after the system entered a sleep state, the boot block code may measure the legacy BIOS code and the code supporting the legacy BIOS code in memory. The boot block code may compare the measurement with the value stored in the secure location by the POST BIOS. If the measurement does not equal the value stored in the secure location by the POST BIOS, then modification of either the legacy BIOS code and/or code supporting the legacy BIOS code is detected.

In one embodiment of the present invention, a method for detecting modifications to code placed in memory by the POST BIOS may comprise the step of initiating the POST operation. The method may further comprise retrieving code from a portion of a flash memory located in a secure area. The method may further comprise measuring the retrieved code to generate a first measurement. The method may further comprise storing the first measurement in the portion of the flash memory located in the secure area. The method may further comprise storing the retrieved code in a memory located in a non-secure area. The method may further comprise measuring the retrieved code in the memory located in the non-secure area after receiving an awakening event to generate a second measurement. The method may further comprise indicating the retrieved code stored in the memory was modified if the first measurement is not equal with the second measurement.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a Trusted Computing Performance Alliance (TCPA) based computing system; and

FIG. 2 is a flowchart of a method for detecting modifications to code placed in memory by the POST BIOS during a POST operation in accordance with an embodiment of the present invention.

### DETAILED DESCRIPTION

The present invention comprises a method, computer program product and system for detecting modifications to code placed in memory by the POST BIOS during a POST operation. In one embodiment of the present invention, the POST BIOS may measure the legacy BIOS code and the code supporting the legacy BIOS during the POST operation and storing that measurement in a secure location, e.g., flash memory module within the trusted building block, an EEPROM module that can be locked to prevent access before the operating system starts, or a TPM module. The legacy BIOS code and the code supporting the legacy BIOS code may be stored in memory by the POST BIOS during the POST operation. After the POST operation completes and the operating system is booted, the system may run in an activated state. The system may then enter a sleep state after a period of inactivity. Upon the system receiving an awakening event after the system entered a sleep state, the boot block code may measure the legacy BIOS code and the code supporting the legacy BIOS code stored in memory. The boot block code may compare the measurement with the value stored in the secure location by the POST BIOS. If the measurement does not equal the value stored in the secure location by the POST BIOS, then modification of either the legacy BIOS code and/or code supporting the legacy BIOS code is detected.

Although the present invention is described with reference to a TCPA computing system, it is noted that the principles of the present invention may be applied to any computing system where the POST BIOS stores code in a non-secure area of memory during the POST operation. It is further noted that embodiments applying the principles of the present invention to such systems, would fall within the scope of the present invention.

It is further noted that although the present invention is described with reference to the legacy BIOS code and the code used to support the legacy BIOS code, that the principles of the present invention apply to any code placed in a non-secure area of memory by the POST BIOS code during the POST operation. It is further noted that embodiments applying the principles of the present invention to such code would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

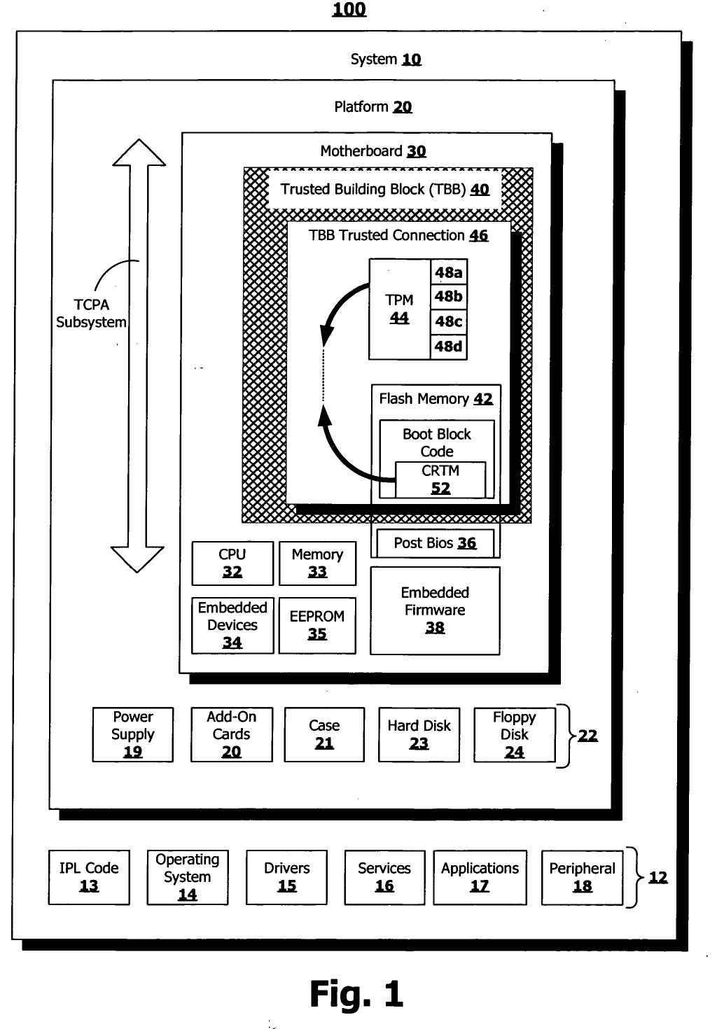

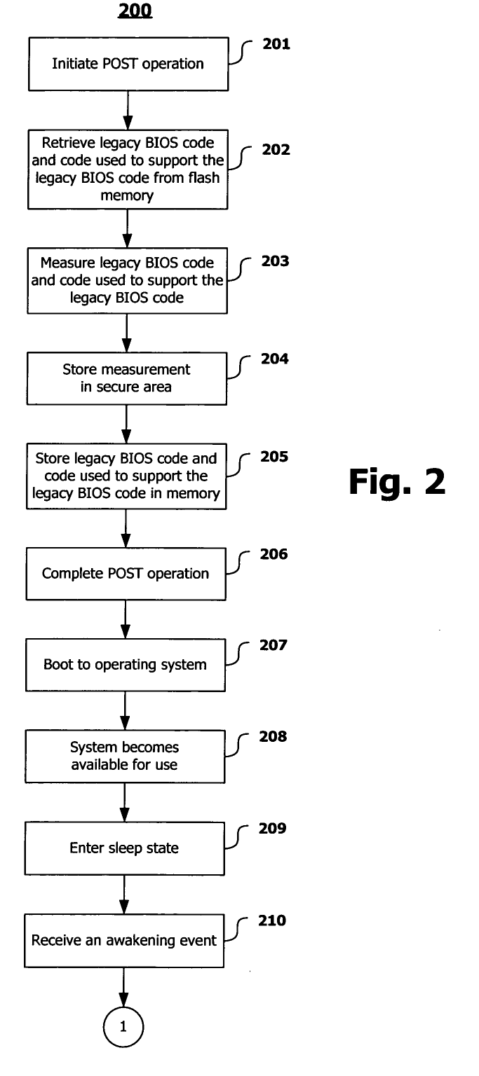

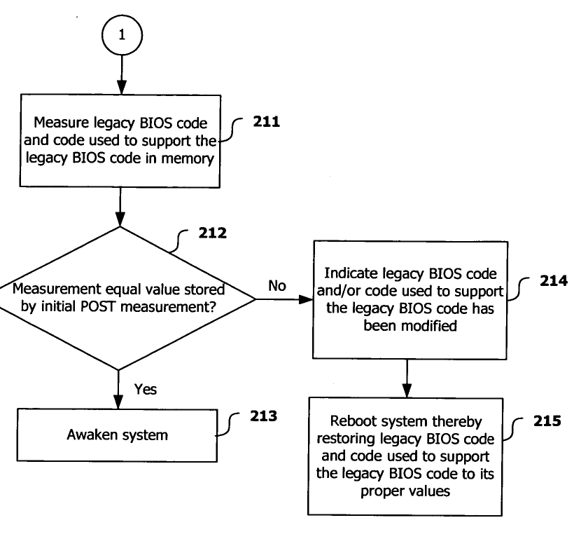

As stated in the Background Information section, a program, such as a virus, may modify the contents of the legacy BIOS code or other code, e.g., ACPI code, USB interface support code, used to support the legacy BIOS code as these codes are not stored in a secure area, e.g., within TBB 40 (FIG. 1), but instead are stored in a non-secure area, e.g., memory 33 (FIG. 1). For example, a Trojan horse routine may be implanted in the legacy BIOS code to capture hardfile password keystrokes entered by the user upon the awakening of system 100 (FIG. 1). Upon the capture of the password, another user may access the operating system of the system and consequently remove the contents of the hardfile to be stored on another system. If, however, modifications to the legacy BIOS code or code used to support the legacy BIOS code were detected prior to exiting the sleep state, then the system may be prevented from being awakened thereby preventing a virus from capturing password keystrokes. Therefore, there is a need in the art to detect modifications to the legacy BIOS code or code used to support the legacy BIOS code after the booting of the system upon the exiting of the sleep state. A method for detecting modifications to the legacy BIOS code or code used to support the legacy BIOS code after the booting of the system upon the exiting of the sleep state is described below in association with FIG. 2.

Prior to discussing FIG. 2, it is noted that TCPA computing system 100 (FIG. 1) comprises CPU 32 (FIG. 1) coupled to memory 33 (FIG. 1) as well as a portion of flash memory 42 (FIG. 1) located outside TBB 40 (FIG. 1) which stores POST BIOS 36 (FIG. 1). Further, CPU 32 is coupled to TBB 40 containing a portion of flash memory 42 which stores boot block code 50 (FIG. 1). CPU 32 may be configured to execute the instructions of boot block code 50 and POST BIOS 36 that may be loaded in memory 33 where these instructions are described as steps performed by boot block code or POST BIOS 36, respectively, in FIG. 2. It is further noted that CPU 32 may be further configured to execute other instructions, e.g.; initiate POST operation, boot to operating system, entering system in sleep state, loaded in memory 33 that are involved in detecting modifications to the legacy BIOS code or code used to support the legacy BIOS code.

Implementations of embodiments of the present invention include implementations as a computer system programmed to execute the method or methods described herein, and as a computer program product. According to the computer system implementations, sets of instructions for executing the method or methods are resident in memory, e.g., memory 33, of one or more computer systems configured generally as described above. Until required by TCPA computing system 100, the set of instructions may be stored as a computer program product in another computer memory. Furthermore, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 2—Method for Detecting Modifications to Code Placed in Memory by POST BIOS during POST Operation

FIG. 2 is a flowchart of a method for detecting modifications to code, e.g., legacy BIOS, ACPI code, USB interface support code, placed in memory 33 (FIG. 1) by POST BIOS 36 (FIG. 1) during a POST operation in accordance with an embodiment of the present invention.

Referring to FIG. 2, in conjunction with FIG. 1, in step 201, a POST operation is initiated. POST is an initialization code which configures system 100 utilizing initialization settings stored in storage.

In step 202, POST BIOS 36 retrieves the legacy BIOS code and the code used to support the legacy BIOS code from the portion of flash memory 42 within TBB 40. Since the legacy BIOS code and the code used to support the legacy BIOS code are stored within the portion of flash memory 42 residing within TBB 40, these codes are located within a secure location. Secure location may refer to an area that is isolated from tampering by a third party vendor or software.

In step 203, POST BIOS 36 measures the retrieved code (legacy BIOS code and the code used to support the legacy BIOS code). Measurement referred to herein means hashing the code. In step 204, the measurement is stored in a secure area. In one embodiment, the measurement may be encrypted using a cryptographic algorithm and stored in the portion of flash memory 42 located within TBB 40. Encrypting is well known in the art and consequently will not be described in detail for the sake of brevity. In another embodiment, the measurement may be stored within EEPROM 35 which may be locked, such as by setting a hardware bit on EEPROM 35, upon storage of the measurement thereby making EEPROM 35 inaccessible. Upon the execution of boot block code 50, such as upon receipt of an awakening event, a hardware bit on EEPROM 35 may be reset thereby making EEPROM 35 accessible to boot block code 50. In another embodiment, the measurement may be stored within TPM module 44.

In step 205, POST BIOS 36 stores the legacy BIOS code and the code used to support the legacy BIOS code in memory 33.

In step 206, the POST operation is completed. In step 207, system 100 boots to operating system 14. In step 208, system 100 becomes activated and available for use.

In step 209, system 100 enters a sleep state. System 100 may enter a sleep state during periods of inactivity in order to reduce power consumption as discussed above.

In step 210, system 100 receives an awakening event. An awakening event may be, for example, a user's keystroke or receipt of electronic mail.

In step 211, boot block code 50 measures the legacy BIOS code and code used to support the legacy BIOS code in memory 33. Boot block code 50 may, in the initial stages after receipt of an awakening event, measure the legacy BIOS code and the code used to support the legacy BIOS code in memory 33.

In step 212, boot block code 50 compares the measurement in step 211 with the value stored in the secure location, e.g., portion of flash memory 42 in TBB 40, EEPROM module 35, TPM module 44, of the measurement of the legacy BIOS code and the code used to support the legacy BIOS code performed by POST BIOS 36 during the POST operation in step 203. In one embodiment, as stated above, the measurement of the legacy BIOS code and the code used to support the legacy BIOS code may be stored within EEPROM 35 which may be locked, such as by setting a hardware bit on EEPROM 35, upon storage of the measurement thereby making EEPROM 35 inaccessible. Upon the execution of boot block code 50, such as upon receipt of an awakening event, a hardware bit on EEPROM 35 may be reset thereby making EEPROM 35 accessible to boot block code 50. Boot block code 50 may then be able to read the measurement of the legacy BIOS code and the code used to support the legacy BIOS code performed by POST BIOS 36 during the POST operation in step 203.

If the measurement in step 211 equals the value stored in the secure location, e.g., portion of flash memory 42 in TBB 40, of the measurement of the legacy BIOS code and the code used to support the legacy BIOS code performed by POST BIOS 36 during the POST operation in step 203, then, in step 213, boot block code 50 awakens system 100 using the normal process of awakening system 100.

If, however, the measurement in step 211 does not equal the value stored in the secure location, e.g., portion of flash memory 42 in TBB 40, of the measurement of the legacy BIOS code and the code used to support the legacy BIOS code performed by POST BIOS 36 during the POST operation in step 203, then, in step 214, boot block code 50 indicates modification of the legacy BIOS code and/or the code used to support the legacy BIOS code. For example, boot block code 50 may issue an error message to the user of system 100 indicating tampering of memory 33.

In step 215, boot block code 50 reboots system 100 thereby restoring the legacy BIOS code and the code used to support the legacy BIOS code to its proper values.

It is noted that method 200 may include other and/or additional steps that, for clarity, are not depicted. It is further noted that method 200 may be executed in a different order presented and that the order presented in the discussion of FIG. 2 is illustrative. It is further noted that certain steps in method 200 may be executed in a substantially simultaneous manner.

Although the system, method and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for detecting modifications to code placed in memory by the Power On Self Test (POST) Basic Input/Output System (BIOS) comprising the steps of:
initiating said POST operation;
retrieving code from a flash memory;
measuring said retrieved code to generate a first measurement;
storing said first measurement in a secure area;
storing said retrieved code in a memory located in a non-secure area;
measuring said retrieved code stored in said memory located in said non-secure area after receiving an awakening event to generate a second measurement; and
indicating said retrieved code stored in said memory was modified if said first measurement is not equal with said second measurement.

2. The method as recited in claim 1 further comprising the step of:
awakening a system if said first measurement is equal with said second measurement.

3. The method as recited in claim 1, wherein said indication comprises an error message.

4. The method as recited in claim 1 further comprising the step of:
rebooting a system thereby restoring said retrieved code to its proper values.

5. The method as recited in claim 1, wherein said retrieved code comprises one or more of the following: legacy BIOS code and code used to support said legacy BIOS code.

6. The method as recited in claim 5, wherein said code used to support said legacy BIOS code comprises one or more of the following: Universal Serial Bus (USB) interface support code and code for power management routines.

7. The method as recited in claim 1, wherein said secure area is located within a trusted building block of a system.

8. The method as recited in claim 1, wherein said secure area comprises a lockable Electrically Erasable Programmable Read Only Memory (EEPROM) module.

9. A computer program product embodied in a machine readable medium for detecting modifications to code placed in memory by the Power On Self Test (POST) Basic Input/Output System (BIOS) comprising the programming steps of:
initiating said POST operation;
retrieving code from a flash memory;
measuring said retrieved code to generate a first measurement;
storing said first measurement in a secure area;
storing said retrieved code in a memory located in a non-secure area;
measuring said retrieved code stored in said memory located in said non-secure area after receiving an awakening event to generate a second measurement; and
indicating said retrieved code stored in said memory was modified if said first measurement is not equal with said second measurement.

10. The computer program product as recited in claim 9 further comprising the programming step of:
awakening a system if said first measurement is equal with said second measurement.

11. The computer program product as recited in claim 9, wherein said indication comprises an error message.

12. The computer program product as recited in claim 9 further comprising the programming step of:
rebooting a system thereby restoring said retrieved code to its proper values.

13. The computer program product as recited in claim 9, wherein said retrieved code comprises one or more of the following: legacy BIOS code and code used to support said legacy BIOS code.

14. The computer program product as recited in claim 13, wherein said code used to support said legacy BIOS code comprises one or more of the following: Universal Serial Bus (USB) interface support code and code for power management routines.

15. The computer program product as recited in claim 9, wherein said secure area is located within a trusted building block of a system.

16. The method as recited in claim 9, wherein said secure area comprises a lockable Electrically Erasable Programmable Read Only Memory (EEPROM) module.

17. A system, comprising:
a memory;
a processor coupled to said memory;
a first portion of a flash memory coupled to said processor, wherein said first portion of said flash memory comprises a Power On Self Test (POST) Basic Input/Output System (BIOS) code; and
a Trusted Building Block (TBB) coupled to said processor, wherein said TBB is configured to ensure integrity of said system, wherein said TBB comprises:
a second portion of said flash memory, wherein said second portion of said flash memory in said TBB comprises:
a boot block code, wherein said boot block code comprises code to reset said system; and
code to be moved from said second portion of said flash memory to said memory by said POST BIOS code during a POST operation;
wherein said processor, responsive to said POST BIOS code, comprises:
circuitry operable for retrieving said code from said second portion of said flash memory during said POST operation;
circuitry operable for measuring said retrieved code to generate a first measurement;
circuitry operable for storing said first measurement in a secure area; and
circuitry operable for storing said retrieved code in said memory; and
wherein said processor, responsive to said boot block code, comprises:
circuitry operable for measuring said retrieved code stored in said memory after receiving an awakening event to generate a second measurement; and
circuitry operable for indicating said retrieved code stored in said memory was modified if said first measurement is not equal with said second measurement.

18. The system as recited in claim 17, wherein said processor, responsive to said boot block code, further comprises:
circuitry operable for awakening said system if said first measurement is equal with said second measurement.

19. The system as recited in claim 17, wherein said indication comprises an error message.

20. The system as recited in claim 17, wherein said processor, responsive to said boot block code, comprises:
circuitry operable for rebooting said system thereby restoring said retrieved code to its proper values if said first measurement is not equal with said second measurement.

21. The system as recited in claim 17, wherein said retrieved code comprises one or more of the following: legacy BIOS code and code used to support said legacy BIOS code.

22. The system as recited in claim 21, wherein said code used to support said legacy BIOS code comprises one or more of the following: Universal Serial Bus (USB) interface support code and code for power management routines.

23. The system as recited in claim 17, wherein said secure area is located within said TBB.

24. The system as recited in claim 17 further comprising:
a lockable Electrically Erasable Programmable Read Only Memory (EEPROM) module coupled to said processor, wherein said secure area comprises said lockable EEPROM module.
